(19) United States
(12) Patent Application Publication
(10) Pub. No.: US 2009/0277106 A1
(43) Pub. Date: Nov. 12, 2009

(54) Window frame with hidden nailing channel

(76) Inventor: Daniel J. Cashman, Suffield, CT (US)

Correspondence Address: ALIX YALE & RISTAS LLP, 750 MAIN STREET, SUITE 1400, HARTFORD, CT, 06103, US

(21) Appl. No.: 12/152,068

(22) Filed: May 12, 2008

(51) Int. Cl. E06B 1/04

(52) U.S. Cl. 52/204.1; 52/745.15

(57) ABSTRACT

A mantel for attachment to a wall, comprising a substantially flat elongated base having a back face to confront the wall and an opposite front face. The elongated channel is recessed in the base whereby the front side of the ornamental feature projects from the base. The ornamental feature has a back side insertable in the elongated channel. The channel has a bottom through which attachment hardware can be driven to attach the frame element to the wall before the ornamental feature is inserted in the channel.

### BACKGROUND

The present invention relates to building construction and in particular to window heads, frames, and mantels and the like for attachment to a wall surrounding a wall penetration.

When decorative framing components are to be attached to a wall surrounding a window, window box, door, or similar wall penetration, a typical procedure is to drill holes through the front face of the component, attach the component with screws or the like passing through the drill holes, filling the drill holes with plastic wood, putty or the like, and then painting or touching up the exposed surface beneath the drill holes.

This procedure is time-consuming and the finished surfaces can show slight flaws, and unless extreme care is taken to match the pain, or wait until the component has been attached to the wall before the component is painted.

### SUMMARY

It is an object of the invention to provide a novel technique for attaching framing components to a wall.

It is a more particular object to provide a mantel or window head piece for attachment to a wall, which does not require driving attachment fixtures through the front face.

This object is achieved in that the mantel or frame component has a substantially elongated base, an elongated channel in the base, and a removable ornamental feature insertable in the base.

Such a component is attachable to a wall by placing the component with the exposed channel on the wall, driving the attachment hardware through the bottom of the channel into the wall and thereafter inserting the ornamental feature into the channel, preferably secured therein with adhesive.

With the present invention, the attaching hardware is not driven through the front face of the component but rather through a hidden portion of the channel which is later covered by the inserted ornamental feature. The entire component can be painted before attachment, because the front surface is not in any way altered or affected by the attachment technique.

### BRIEF DESCRIPTION OF THE DRAWING

FIG. 1 is a partly oblique front view of a window head or mantel according to the present invention;

FIG. 2 is a front view of the window head shown in FIG. 1, with one of the ornamental features removed to expose the attachment channel;

FIG. 3 is a view similar to FIG. 2, after screws or the like have been driven through the channel into the wall substrate and the ornamental feature pressure reinserted into the channel; and

FIG. 4 is a front elevation view of a door frame that embodies the present invention.

### DETAILED DESCRIPTION

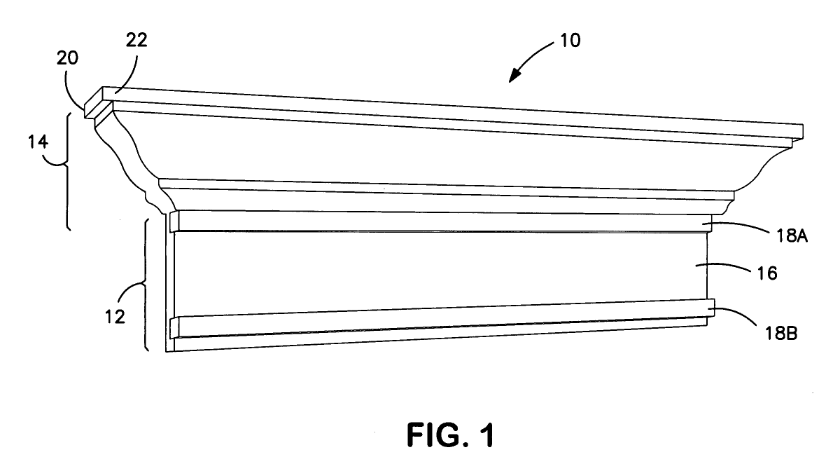

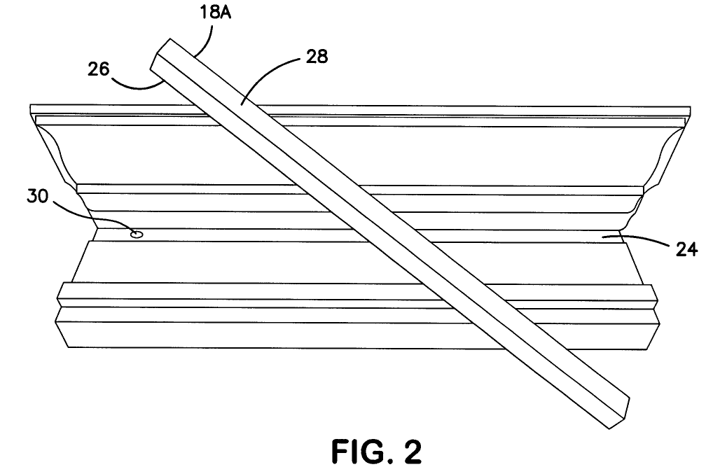

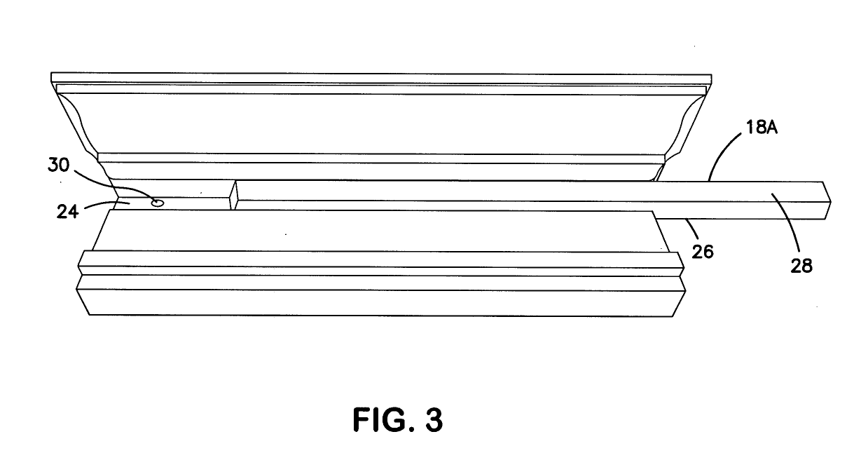

The window head or mantel 10 shown in FIG. 1 comprises a substantially flat base portion 12 and a more ornate upper, cornice portion 14. The base portion has a substantially flat region 16 from which two substantially identical decorative or ornamental features 18A and 18B project forwardly. In the present context, the head can be considered as having a back side 20 for placement against the wall and an exposed front side 22. As further shown in FIGS. 2 and 3, the ornamental feature 18A is removable from the channel 24 in base portion 12. The channel 24 and ornamental features 18A, 18B generally extend all or most of the full length of the base portion 12, but this is not necessary. The ornamental feature 18A has a back portion 26 that fits within the channel 24 and a front portion 28 which in a fully inserted position shown in FIG. 1, projects forwardly to the same extent as the other feature 18B.

The window head is installed with the groove 24 exposed, as shown in FIG. 2. A plurality of predrilled holes 30 may be provided in the bottom of the channel for receiving attachment hardware such as screws, whereby the window head is permanently secured against the wall. After such attachment, the ornamental feature 18A is reinserted into the channel 24 as shown in FIG. 3, thereby establishing the completed appearance as shown in FIG. 1. Preferably, carpenter's glue, or the like, is applied to the channel 24 and the underside 26 of the ornamental feature to assure the integrity of the completed installation.

It can be appreciated that the window head including ornamental feature 18A can receive the final finish whether paint or otherwise, before installation, because none of the exposed surface is affected by the procedure for attaching the head to the wall. In this way, the shape, extent of projection, and coloration of the feature 18A replicates these characteristics of the permanently installed feature 18B.

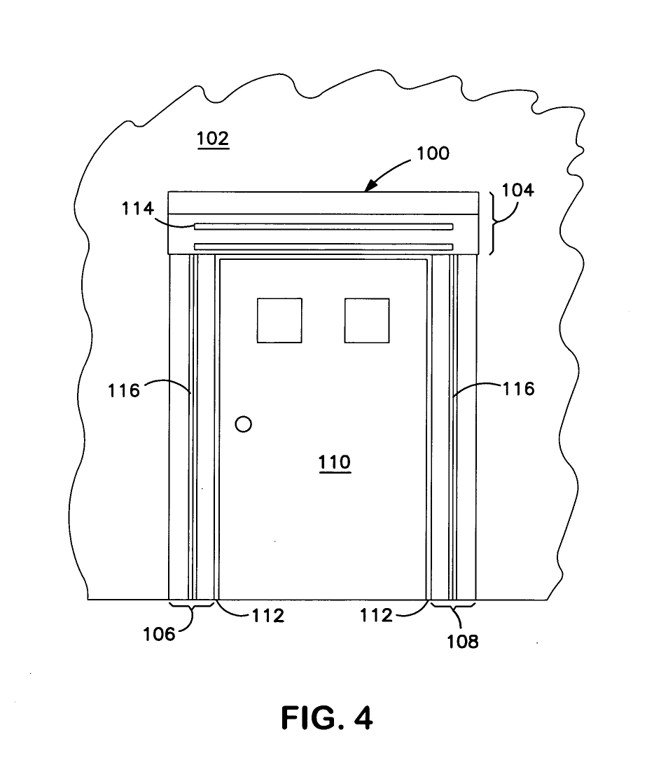

FIG. 4 shows another embodiment of a door frame 100 attached to a wall 102. The door frame has a top element or head 104 and side elements 106, 108. These elements surround the door 110, leaving a slight gap 112 for accommodating hinges, insulation and the like, as is well known. The decorative features 114A, 114B at the head 104 are substantially the same as shown and described with respect to FIGS. 1-3, except that the lengths of the channels and features are less than the full length of the head 104. It can be appreciated that a similar technique may be used on the side elements 106, 108. In this instance, one or two vertically oriented ornamental features are centered within the frame elements 106, 108. A single channel could be present whereby the side elements 106, 108 are secured to the wall surrounding the sides of door 110. After securement, elongated ornamental elements can be inserted in the channels with adhesive, as complementary ornamentation to the ornamentation 114 at the head 104. It should also be appreciated that the technique could be used only on the side elements, or both as shown.

As used herein the term “frame” should be understood as covering including frames for windows, with or without window boxes, doors, ventilation inlets or outlets, or analogous penetrations in the walls of buildings.

What is claimed:

1. Frame for attachment around a wall opening, comprising;
a plurality of elongated, rigid frame elements connected together as a frame sized to at least partially surround the wall opening;
said frame having a back face to confront said wall and an opposite front face;
one of said frame elements having an ornamental region on the front face including a feature projecting forwardly from the base;
said ornamental feature having a back side insertable in an elongated channel recessed in the base whereby the front side projects from the base;
said channel having a bottom through which attachment hardware can be driven to attach said one frame element to the wall before said ornamental feature is inserted in said channel.

2. The frame according to claim 1, wherein the base is substantially flat.

3. The frame according to claim 1, wherein said channel extends in a straight line along the length of the element and another feature identical to the feature in the channel is permanently attached on the face and uniformly spaced from the channel.

4. The frame according to claim 1, wherein the channel extends in a straight line over the entire length of the element.

5. The frame according to claim 1, wherein said one element is the head of a four-sided window frame.

6. The frame according to claim 5, wherein the head has additional ornamental features integrally extending laterally and forwardly from the base beyond the projection of said ornamental feature insertable in the channel.

7. A mantel for attachment to a wall, comprising;
a substantially flat elongated base having a back face to confront said wall and an opposite front face;
an elongated channel recessed in the base whereby the front side of the ornamental feature projects from the base;
an ornamental feature having a back side insertable in the elongated channel;
said channel having a bottom through which attachment hardware can be driven to attach on said frame element to the wall before said ornamental feature is inserted in said channel.

8. A method of attaching a window frame headpiece to a wall, comprising;
selecting a headpiece having a longitudinally extending, recessed channel;
placing the headpiece on the wall;
driving attachment hardware through the recess into the wall; and
inserting a decorative feature into the channel such that a front portion of the feature projects from the channel.

9. The method of claim 8, including the step of applying an adhesive to one or both of the channel and ornamental feature before the ornamental feature is inserted into said channel.

10. The method of claim 8, wherein the headpiece includes a permanent ornamental feature extending in parallel with the channel, whereby after insertion of said ornamental feature in the channel to substantially identical ornamental features are visible on said headpiece.
